(19) United States
(12) Patent Application Publication
(10) Pub. No.: US 2014/0258529 A1
(43) Pub. Date: Sep. 11, 2014

(54) DEVICE-SPECIFIC RESTRICTIVE CONTENT DELIVERY

(71) Applicant: Uniloc Luxembourg S.A., Luxembourg (LU)

(72) Inventor: Craig S. Etchegoyen, Plano, TX (US)

(73) Assignee: UNILOC LUXEMBOURG S.A., Luxembourg (LU)

(21) Appl. No.: 14/176,928

(22) Filed: Feb. 10, 2014

Related U.S. Application Data
(60) Provisional application No. 61/774,316, filed on Mar. 7, 2013.

(51) Int. Cl. H04L 12/24

(52) U.S. Cl. CPC H04L 41/50
USPC 709/225

(57) ABSTRACT

A content control server implements a service similar to the National Do-Not-Call Registry for on-line content in which a user of a device can request that advertising content received from an ad server be restricted to one or more types of acceptable content. The types of content that are to be allowed and/or denied delivery to the device are associated with an identifier of the device. The identifier can be a digital fingerprint of the device. The types of content that can be controlled in the manner described herein are organized in a hierarchy.

This application claims priority to U.S. Provisional Application 61/774,316, filed Mar. 7, 2013, which is fully incorporated herein by reference.

### BACKGROUND OF THE INVENTION

1. Field of the Invention

The present invention relates generally to computer networks and, more particularly, methods of and systems for improving a person's control over on-line content presented to the user.

2. Description of the Related Art

Advertising in various forms has crept its way into nearly everyone's life. People experience few waking moments that don't involve some sort of sales pitch. In most contexts, the sales pitches are limited in time, context, and content. For example, obscene content is not permitted on most Television and radio stations and in public places like billboards. Advertising on Television and radio are limited, at least as a practical matter, to a certain portion of time relative to the time in which the non-advertising content is presented. For example, most radio stations don't advertise more than 20 minutes of every hour for fear of losing their audience.

Advertising on-line is different. There's nothing to prevent a web page from having 80% of its area devoted to advertising rather than non-advertising, substantive content. There's nothing to prevent advertisements with content that is offensive, sexual, or otherwise undesirable being displayed.

What is needed is a way to improve a person's ability to control the nature of content presented to the person when using on-line products and services.

### SUMMARY OF THE INVENTION

In accordance with the present invention, a content control server implements a service similar to the National Do-Not-Call Registry implemented in the United States for on-line content in which a user of a device can request that advertising content received from an ad server be restricted to one or more types of acceptable content. The user specifies one or more types of content that are to be denied delivery to the device. The user can specify these types of content explicitly or implicitly by specifying one or more types content that are exclusively allowed to be delivered to the device.

Prior to delivering content to the device, a server or other source of the content provides data representing one or more types of data intended to be delivered to the device and an identifier of the device. The content control server retrieves the data representing whether the types of data are to be allowed or denied delivery to the device and sends data representing the results to the server. The server then delivers only content of allowed types to the device.

The types of content that are to be allowed and/or denied delivery to the device are associated with an identifier of the device. By associating the types with an identifier of the device and not the user, the content control is completely anonymous. The identifier can be a digital fingerprint of the device.

The types of content that can be controlled in the manner described herein are organized in a hierarchy. Accordingly, the user can specify broad or very specific types of content to be allowed or denied delivery.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a client device, a server, an ad server, and a content control server that cooperate to restrict types of content that can be delivered to the client device in accordance with one embodiment of the present invention.

FIG. 2 is a transaction flow diagram illustrating registration of the device of FIG. 1 with the content control server of FIG. 1 in accordance with the present invention.

FIG. 3 is a transaction flow diagram illustrating control of the types of content to be delivered to the device of FIG. 1 in accordance with the present invention.

FIG. 4 is a block diagram showing a device record used by the content control server of FIG. 1 to control of the types of content to be delivered to the device of FIG. 1 in accordance with the present invention.

FIG. 5 is a block diagram showing a content type record that specifies a type of content that can be controlled by the content control server of FIG. 1.

FIG. 6 is a block diagram showing the content control server of FIG. 1 in greater detail.

FIG. 7 is a block diagram showing the client device of FIG. 1 in greater detail.

### DETAILED DESCRIPTION

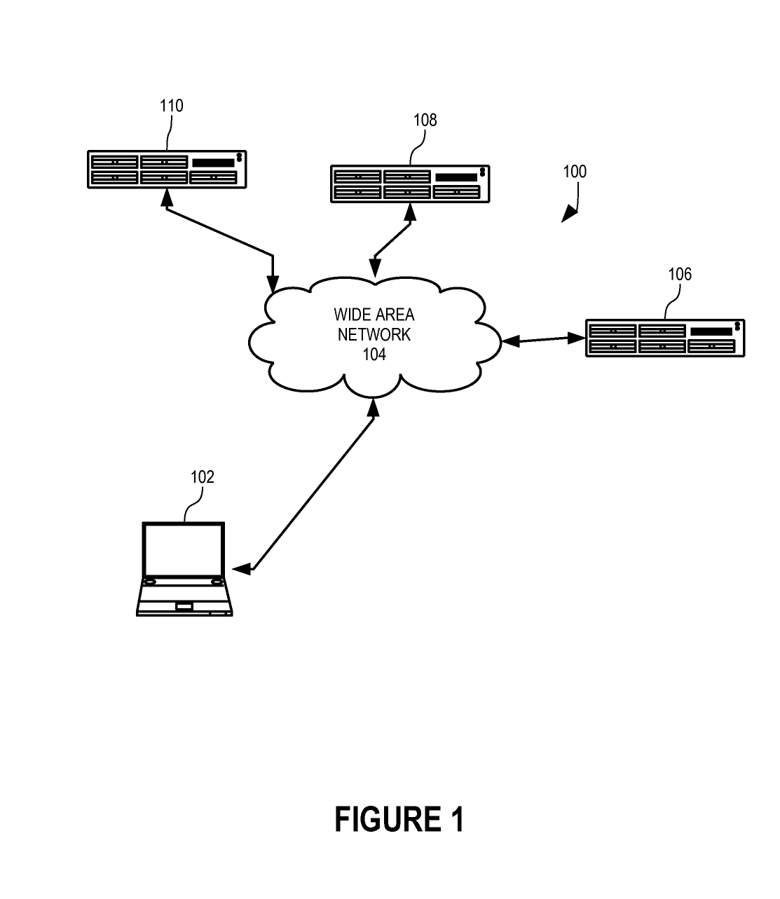

In accordance with the present invention, a content control server 110 (FIG. 1) implements a service similar to the U.S.'s National Do-Not-Call Registry for on-line content in which a user of device 102 can request that advertising content received from an ad server 108 be restricted to one or more types of acceptable content.

Device 102 is connected to a wide area network (WAN) 104 and, therethrough, to a web server 106, ad server 108, and content control server 110. In this illustrative embodiment, WAN 104 is the Internet, web server 106 provides a web-based service that the user of device 102 is using, and ad server 108 delivers advertisements to be included with the web-based service provided by web server 106.

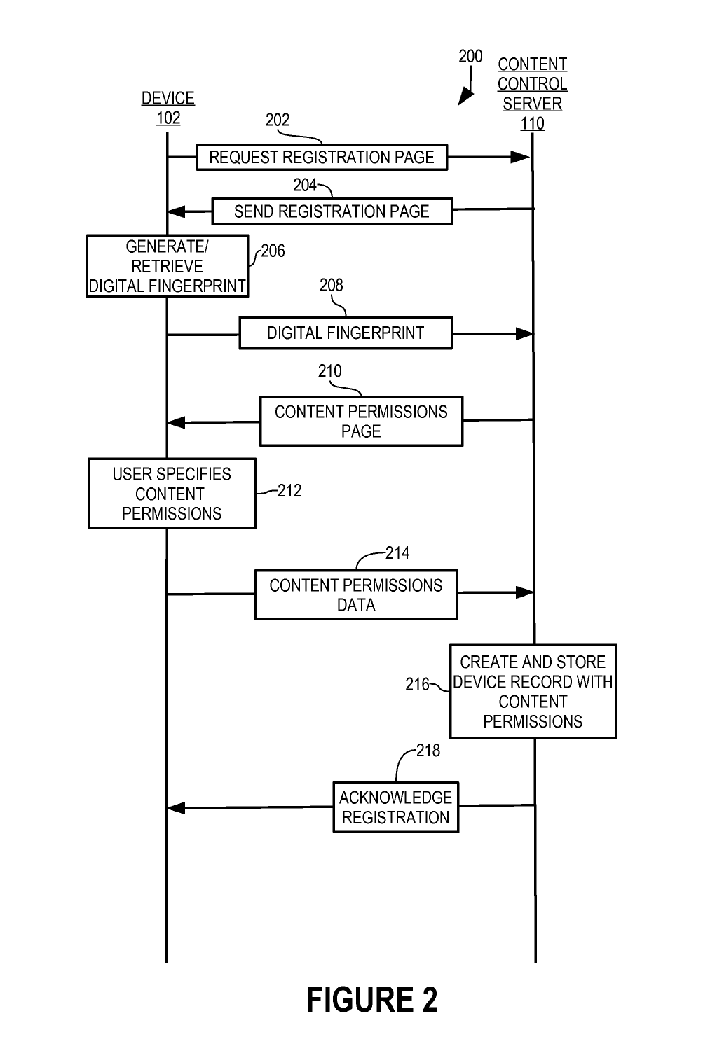

Transaction flow diagram 200 (FIG. 2) represents the manner in which device 102 registers itself with content control server 108 such that content to be delivered to device 102 can subsequently be controlled.

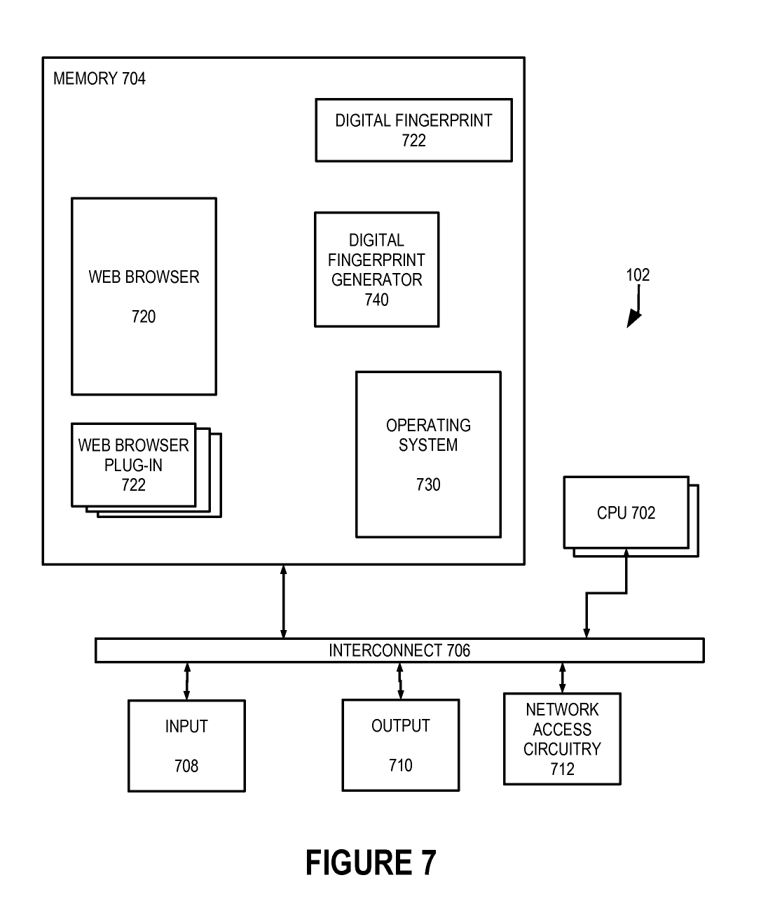

In step 202, device 102 sends a request for registration to content control server 110. The request can be in the form of a URL specified by the user of device 102 using a web browser 720 (FIG. 7) executing in device 102 and conventional user interface techniques involving physical manipulation of user input devices 708. Web browser 720 and user input devices 708 and other components of device 102 are described in greater detail below.

In step 204 (FIG. 2), content control server 110 sends a registration page to device 102, and the registration page includes a request for device attributes of device 102 from which a globally unique identifier (GUID) for device 102 can be formed.

The request sent to device 102 includes content that causes web browser 720 (FIG. 7) of device 102 to gather attribute data representing hardware and other configuration attributes of device 102. In one embodiment, a web browser plug-in 722 is installed in device 102 and, invoked by web browser 720, processes the content of the web page to gather the attribute data in step 206. In other embodiments, the attribute data can be gathered by other forms of logic of device 102, such as digital fingerprint generator 740 installed in device 102. The various elements of device 102 and their interaction are described more completely below.

In this illustrative embodiment, web browser plug-in 722 (FIG. 7) or digital fingerprint generator 740 encrypts the attribute data using a public key of content control server 110 and public key infrastructure (PKI).

In step 208 (FIG. 2), device 102 sends the attribute data that was gathered in step 206 to content control server 110.

In response to receipt of the attribute data in step 208, content control server 110 sends a content permissions page to device 102. The content permissions page includes a user-interface that the user of device 102 can use to specify various types of content that are allowed and various types of content that are prohibited for presentation on device 102.

In step 212, web browser 720 (FIG. 7) of device 102 displays the content permissions page through one or more output devices 710 and receives signals generated by the user through physical manipulation of one or more of input devices 708, where the signals represent choices made by the user as to which types of content are allowed and which are prohibited for delivery to device 102.

In step 214 (FIG. 2), device 102 sends content permissions data representing the user's choices to content control server 110.

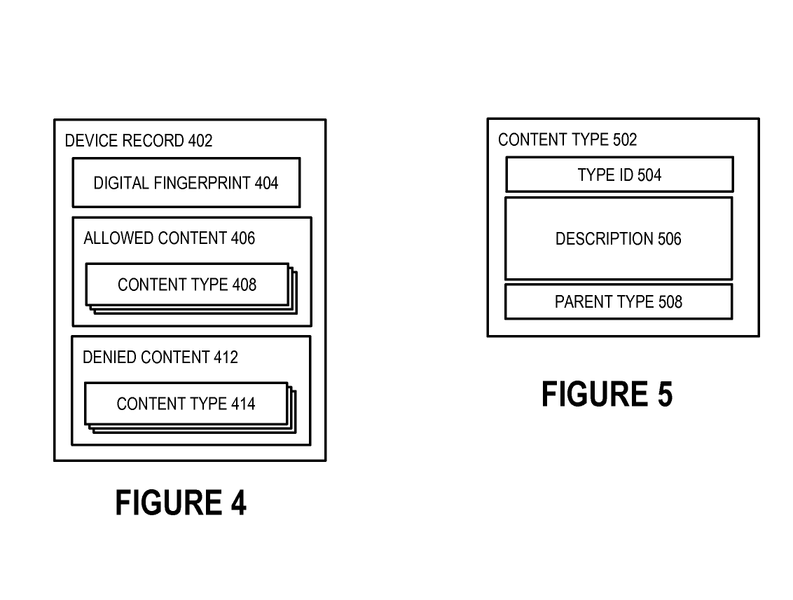

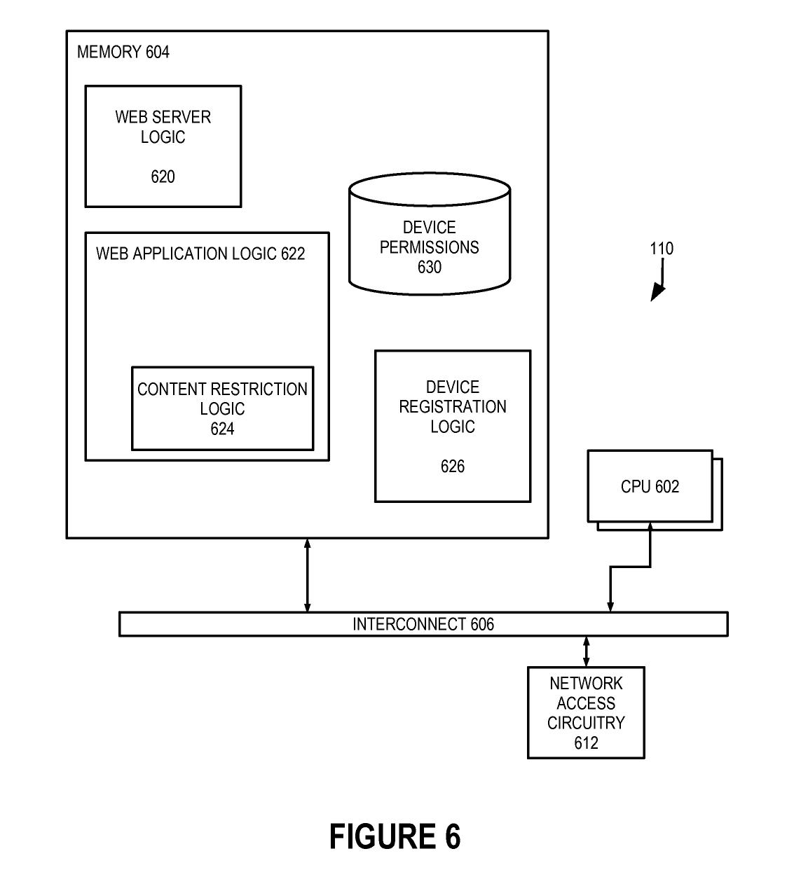

In step 216, device registration logic 620 (FIG. 6) of content control server 110 creates a device registration record for device 102 from the received attribute and content permissions data. Content control server 110 creates a device registration record in the form of device record 402 (FIG. 4) for device 102 by creating a digital fingerprint 404 for device 102 from the received attribute data as a globally unique device identifier. Device record 402 is described more completely below in greater detail.

In step 218 (FIG. 2), content control server 110 sends a report of successful registration to device 102. After step 218 (FIG. 2), processing according to transaction flow diagram 200 completes and device 102 is registered for subsequent content control with content control server 110.

Content control server 110 includes device permissions 630 (FIG. 6) that in turn includes device records such as device record 402 (FIG. 4). Device record 402 specifies the types of content that are allowed and/or denied to be delivered to device 102. Digital fingerprint 404 of device record 402 identifies device 102 as the device to which device record 402 pertains. Digital fingerprints offer the advantage of being more stable and less amenable to spoofing that are IP addresses and MAC addresses. Digital fingerprints are known and described in U.S. Patent Application Publication 2011/0093503 for “Computer Hardware Identity Tracking Using Characteristic Parameter-Derived Data” by Craig S. Etchegoyen (filed Apr. 21, 2011) and that description is incorporated herein in its entirety by reference.

Device record 402 (FIG. 4) also includes an allowed content record 406 and denied content record 412. Allowed content record 406 includes a number of content type records 408, each of which identifies a type of content that is allowed to be delivered to device 102. Denied content record 412 includes a number of content type records 414, each of which identifies a type of content that is prohibited from being delivered to device 102.

Content type record 502 (FIG. 5) shows the structure of content type records 408 and 414 in greater detail.

Type identifier 504 is an identifier of the particular content type represented by content type record 502 (sometimes referred to as the subject content type in the context of FIG. 5) and is unique among content type identifiers used by content control server 110.

Description 506 is a textual description of the subject content type. Description 506 is used to produce the permissions page sent in step 210 (FIG. 2) so that the user can be informed of the particular content types as the user specifies which are allowed and which are prohibited.

Parent type record 508 identifies a content type record as a parent content type in a content type hierarchy. Organizing content types as a hierarchy allows the user to select large categories of content types and/or finely detailed content types. For example, one user can deny access to device 102 to all advertising and another user can deny access to only advertising of an adult nature and for violent video games.

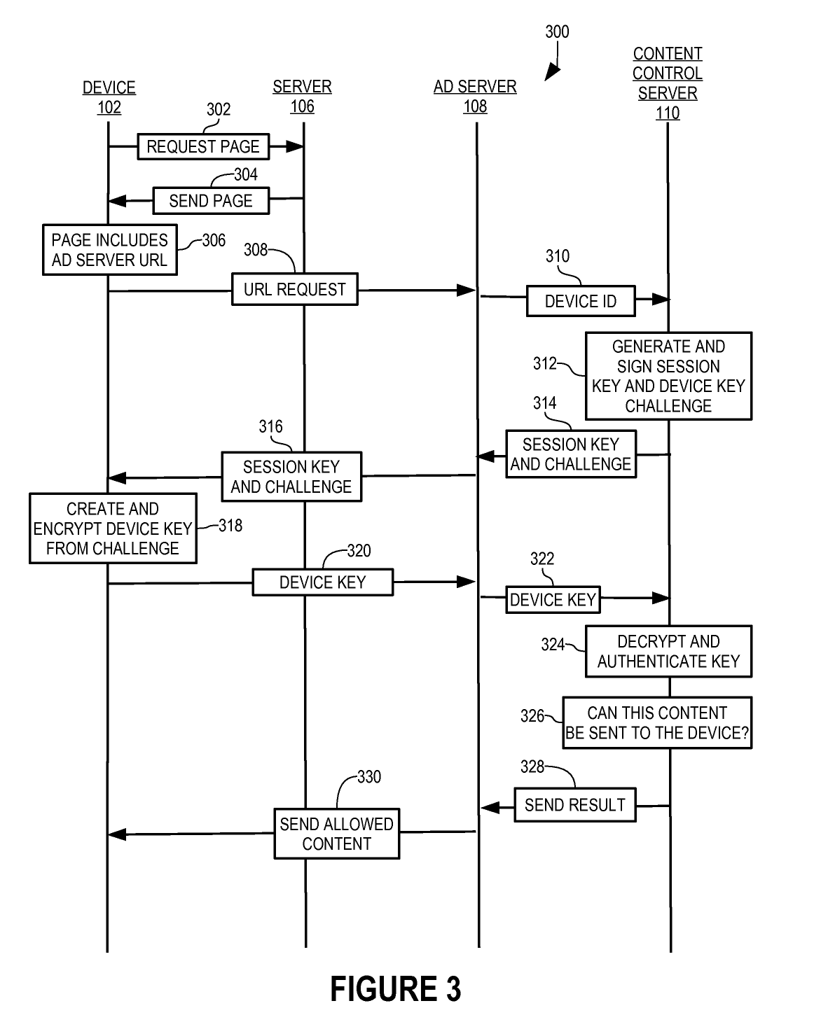

Transaction flow diagram 300 (FIG. 3) illustrates the use of content control server 110 to control types of content delivered to device 102.

In step 302, device 102 sends a request for a web page to server 106. The request can be in the form of a URL specified by the user of device 102 using web browser 720 (FIG. 7) and conventional user interface techniques involving physical manipulation of user input devices 708.

In step 304 (FIG. 3), server 106 sends the web page that is identified by the request received in step 302. In this illustrative example, the web page sent to device 102 includes URLs to advertising content to be served by ad server 108. In presenting the web page within device 102, web browser 720 (FIG. 7) parses those URLs in step 306 (FIG. 3) and sends those URLs to ad server 108 in step 308.

In step 310, ad server 108 sends an identifier of device 102 and data identifying the particular type of content requested by the URLs received in step 308 to content control server 110. The device identifier can be received from device 102 in step 308 or can be an identifier of device 102 that is accessible to ad server 108, such as a MAC address for example.

In step 312, content control server 110 generates and cryptographically signs a session key. Session keys and their generation are known and are not described herein. In addition, content control server 110 creates a device key challenge and encrypts the device key challenge using a public key of device 102 and public-key infrastructure (PKI).

To create the device key challenge, content control server 110 uses the device identifier received in step 310 to identify and retrieve the particular device record 402 (FIG. 4) that corresponds to device 102. The device key challenge specifies all or part(s) of a number of attribute data records of digital fingerprint 404 are to be used by device 102 to form a dynamic device key for proper identification and authentication.

In step 314 (FIG. 3), content control server 110 sends the session key and the device key challenge to ad server 108.

In step 316, ad server 108 sends a “device authenticating” page to device 102 along with the device key challenge. The “device authenticating” page includes content that causes device 102 to produce a dynamic device key in accordance with the device key challenge.

The device key challenge causes web browser 720 (FIG. 7) of device 102 to generate a device identifier, sometimes referred to herein as a dynamic device key (DDK), for device 102 in the form of digital fingerprint 742. In one embodiment, a web browser plug-in 722 is installed in client device 102 and, invoked by web browser 720, processes the content of the web page to generate digital fingerprint 742. In other embodiments, digital fingerprint 742 can be generated by other forms of logic of device 102, such as digital fingerprint generator 740, which is a software application installed in device 102.

The device key challenge specifies the manner in which digital fingerprint 742 is to be generated from the attributes of device 102. The challenge specifies a randomized sampling of attributes of device 102, allowing the resulting digital fingerprint 742 to change each time device 102 is authenticated. There are a few advantages to having digital fingerprint 742 represent different samplings of the attributes of device 102. One is that any data captured in a prior authentication of device 102 cannot be used to spoof authentication of device 102 using a different device when the challenge has changed. Another is that, since only a small portion of the attributes of device 102 are used for authentication at any time, the full set of attributes of device 102 cannot be determined from one, a few, several, or even many authentications of device 102.

In particular, the device key challenge specifies items of information to be collected from hardware and system configuration attributes of device 102 and the manner in which those items of information are to be combined to form digital fingerprint 742. The generation of a dynamic device key from a device key challenge is described in U.S. Patent Application Publication US 2011/0009092 and those descriptions are incorporated herein.

Once digital fingerprint 742 (FIG. 7) is generated according to the received device key challenge, device 102 encrypts digital fingerprint 742 using a public key of content control server 110 and PKI.

In step 320 (FIG. 3), device 102 sends the encrypted dynamic device key to ad server 108, and ad server 108 sends the encrypted dynamic device key to content control server 110 in step 322.

In step 324, content restriction logic 624 (FIG. 6) of content control server 110 decrypts and authenticates the received DDK. The authentication of a dynamic device key from a device key challenge is described in U.S. Patent Application Publication US 2011/0009092 and those descriptions are incorporated herein. Briefly, content restriction logic 624 applies the same device key challenge to digital fingerprint 404 (FIG. 4) to determine that device record 404 corresponds to device 102 if the resulting DDK matches the one received in step 322 (FIG. 3).

Once device 102 is properly authenticated, content control server 110 determines whether delivery of the types of data to be sent to device 102 by ad server 108 is allowed or denied for device 102 in step 326. In one embodiment, any content of a type represented by any of content type records 408 in allowed content record 406 is allowed and content of all other types is denied. Content is of a type represented by a particular content type record, e.g., content type record 502 (FIG. 5), if the content is of the type represented by type identifier 504 or any type identifier of a parent content type record of content type record 502.

In an alternative embodiment, any content of a type represented by any of content type records 414 in denied content record 412 is denied and content of all other types is allowed. In yet another embodiment, content of a particular type can be represented in both allowed content record 406 and denied content record 412. For example, one of content type records 414 can identify advertising content, one of content type records 408 can identify content that advertises sporting goods, and one of content type records 414 can identify content that advertises sporting goods used for hunting. When processing a particular content type received in step 310 (FIG. 3), content control server 110 determines whether the content type is allowed or denied according to the one of content type records 408 (FIG. 4) and 414 that is most closely related to the received content type in the hierarchy defined by parent type records such as parent type record 508 (FIG. 5). Thus, in this illustrative example, content is denied if it's advertising content unless it's also content that advertises sporting goods that are not for hunting.

In step 328 (FIG. 3), content control server 110 sends data representing whether each of the content types received in step 310 are allowed for device 102 to ad server 108.

In step 330, ad server 108 send any content that is identified by a URL received in step 308 and is allowed for device 102 according to the results received in step 328. In addition, for all content that is identified by a URL received in step 308 and that is denied according to the results received in step 328, ad server 108 sends filler content. Filler content is content that is blank or bland and that fills any space that would have been filled by denied content if the denied content were not denied. Accordingly, web browser 720 (FIG. 7) believes that all content requested in step 308 has been received and will not re-request the content or continue to wait for the content.

Content control server 110 is shown in greater detail in FIG. 6. Content control server 110 includes one or more microprocessors 602 (collectively referred to as CPU 602) that retrieve data and/or instructions from memory 604 and execute retrieved instructions in a conventional manner. Memory 604 can include generally any computer-readable medium including, for example, persistent memory such as magnetic and/or optical disks, ROM, and PROM and volatile memory such as RAM.

CPU 602 and memory 604 are connected to one another through a conventional inter-connect 606, which is a bus in this illustrative embodiment and which connects CPU 602 and memory 604 to network access circuitry 612. Network access circuitry 612 sends and receives data through computer networks such as LAN 104 (FIG. 1).

A number of components of content control server 110 are stored in memory 604. In particular, web server logic 620 and web application logic 622, including content restriction logic 624, are all or part of one or more computer processes executing within CPU 602 from memory 604 in this illustrative embodiment but can also be implemented using digital logic circuitry.

Web server logic 620 is a conventional web server. Web application logic 622 is content that defines one or more pages of a web site that is served by web server logic 620 to client devices such as device 102. Content restriction logic 624 is a part of web application logic 622 that controls the types of content that can be delivered to device 102 in the manner described above.

In addition, device registration logic 626 is all or part of one or more computer processes executing within CPU 602 from memory 604 in this illustrative embodiment but can also be implemented using digital logic circuitry. As used herein, “logic” refers to (i) logic implemented as computer instructions and/or data within one or more computer processes and/or (ii) logic implemented in electronic circuitry. Device registration logic 626 is logic that causes content control server 110 to register devices such as device 102 in the manner described above.

Device permissions 630 is data stored persistently in memory 604 and includes data representing which types of content are allowed to be delivered to various devices. Device permissions 630 can be implemented as all or part of one or more databases.

Device 102 is shown in greater detail in FIG. 7. Device 102 includes one or more microprocessors 702 (collectively referred to as CPU 702) that retrieve data and/or instructions from memory 704 and execute retrieved instructions in a conventional manner. Memory 704 can include generally any computer-readable medium including, for example, persistent memory such as magnetic and/or optical disks, ROM, and PROM and volatile memory such as RAM.

CPU 702 and memory 704 are connected to one another through a conventional interconnect 706, which is a bus in this illustrative embodiment and which connects CPU 702 and memory 704 to one or more input devices 708, output devices 710, and network access circuitry 712. Input devices 708 generate signals in response to, and representative of, physical manipulation by the user and can include, for example, a keyboard, a keypad, a touch-sensitive screen, a mouse, a microphone, and one or more cameras. Output devices 710 present information to the user and can include, for example, a display—such as a liquid crystal display (LCD)—and one or more loudspeakers. Network access circuitry 712 sends and receives data through computer networks such as LAN 104 (FIG. 1).

A number of components of device 102 are stored in memory 704. In particular, web browser 720 is all or part of one or more computer processes executing within CPU 702 from memory 704 in this illustrative embodiment but can also be implemented using digital logic circuitry. Web browser plug-ins 722 are each all or part of one or more computer processes that cooperate with web browser 720 to augment the behavior of web browser 720. The manner in which behavior of a web browser is augmented by web browser plug-ins is conventional and known and is not described herein.

Operating system 730 is all or part of one or more computer processes executing within CPU 702 from memory 704 in this illustrative embodiment but can also be implemented using digital logic circuitry. An operating system (OS) is a set of programs that manage computer hardware resources and provide common services for application software such as web browser 720, web browser plug-ins 722, and digital fingerprint generator 740.

Digital fingerprint generator 740 is all or part of one or more computer processes executing within CPU 702 from memory 704 in this illustrative embodiment but can also be implemented using digital logic circuitry. Digital fingerprint generator 740 facilitates authentication of device 102 in the manner described above.

Digital fingerprint 742 is data stored persistently in memory 704 and can be organized as all or part of one or more databases.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for controlling content delivery to a device through a computer network, the method comprising:
receiving content type data from the device wherein the content type data represents one or more types of content that is to be denied delivery to the device;
storing the content type data with an identifier of the device;
receiving content delivery data representing an intent to deliver one or more types of content to the device;
determining that one or more denied ones of the types of content represented by the content delivery data are also types of content represented by the content type data; and
denying delivery to the device of content of the one or more denied types.

2. The method of claim 1 wherein the device identifier is a digital fingerprint of the device.

3. The method of claim 1 wherein the content type data represents one or more types of content that is to be denied delivery to the device implicitly by explicitly representing one or more types of content that are exclusively to be allowed delivery to the device.

4. The method of claim 1 wherein the content type data represents one or more types of content of a larger collection of types of content wherein the collection of types of content is hierarchical.

5. The method of claim 4 wherein determining that one or more denied ones of the types of content represented by the content delivery data are also types of content represented by the content type data comprises:
determining that the content type data represents a first type of content that is to be denied delivery to the device; and
determining that the content delivery data represents an intent to deliver a second type of content to the device;
wherein the first type of content is a parent of the second type of content within the hierarchy of the collection of types of content.

6. A non-transitory computer readable medium useful in association with a first device which includes one or more processors and a memory, the computer readable medium including computer instructions which are configured to cause the client device, by execution of the computer instructions in the one or more processors from the memory, to control content delivery to a device through a computer network by at least:
receiving content type data from the device wherein the content type data represents one or more types of content that is to be denied delivery to the device;
storing the content type data with an identifier of the device;
receiving content delivery data representing an intent to deliver one or more types of content to the device;
determining that one or more denied ones of the types of content represented by the content delivery data are also types of content represented by the content type data; and
denying delivery to the device of content of the one or more denied types.

7. The computer readable medium of claim 6 wherein the device identifier is a digital fingerprint of the device.

8. The computer readable medium of claim 6 wherein the content type data represents one or more types of content that is to be denied delivery to the device implicitly by explicitly representing one or more types of content that are exclusively to be allowed delivery to the device.

9. The computer readable medium of claim 6 wherein the content type data represents one or more types of content of a larger collection of types of content wherein the collection of types of content is hierarchical.

10. The computer readable medium of claim 9 wherein determining that one or more denied ones of the types of content represented by the content delivery data are also types of content represented by the content type data comprises:
determining that the content type data represents a first type of content that is to be denied delivery to the device; and
determining that the content delivery data represents an intent to deliver a second type of content to the device;
wherein the first type of content is a parent of the second type of content within the hierarchy of the collection of types of content.

11. A device comprising:
at least one processor;
a computer readable medium that is operatively coupled to the processor;
network access circuitry that is operatively coupled to the processor; and
content control logic (i) that executes at least in part in the processor from the computer readable medium and (ii) that, when executed, causes the device to control content delivery to a device through a computer network by at least:
receiving content type data from the device wherein the content type data represents one or more types of content that is to be denied delivery to the device;
storing the content type data with an identifier of the device;
receiving content delivery data representing an intent to deliver one or more types of content to the device;
determining that one or more denied ones of the types of content represented by the content delivery data are also types of content represented by the content type data; and
denying delivery to the device of content of the one or more denied types.

12. The device of claim 11 wherein the device identifier is a digital fingerprint of the device.

13. The device of claim 11 wherein the content type data represents one or more types of content that is to be denied delivery to the device implicitly by explicitly representing one or more types of content that are exclusively to be allowed delivery to the device.

14. The device of claim 11 wherein the content type data represents one or more types of content of a larger collection of types of content wherein the collection of types of content is hierarchical.

15. The device of claim 14 wherein determining that one or more denied ones of the types of content represented by the content delivery data are also types of content represented by the content type data comprises:
determining that the content type data represents a first type of content that is to be denied delivery to the device; and
determining that the content delivery data represents an intent to deliver a second type of content to the device;
wherein the first type of content is a parent of the second type of content within the hierarchy of the collection of types of content.
